(19) United States
(12) Patent Application Publication
(10) Pub. No.: US 2009/0293682 A1
(43) Pub. Date: Dec. 3, 2009

(54) HAND TOOL WITH AN ELBOW STRUCTURE

(76) Inventor: CHIH-CHING HSIEH, Taichung Hsien (TW)

Correspondence Address: BENFAMIN SU, 121 TAICHUNG, P.O. BOX 70, TAICHUNG CITY, 40899, TW

(21) Appl. No.: 12/128,608

(22) Filed: May 28, 2008

(51) Int. Cl. B25B 13/00

(52) U.S. Cl. 81/52

(57) ABSTRACT

A hand tool with an elbow structure includes a handle having a rod longitudinally extending therefrom along an axis of the handle and an elbow structure extending from the rod. The elbow structure has a first section longitudinally connected to the rod along an axis of the rod and a second section slantwise extending from the first section relative to the axis of the rod. The second section forms a first included angle with an axis of the first section and a range of the first included angle is located from 60° to 70°. A driving portion is disposed on a distal end of the second section to be adapted to drive a fastener along an axis of the second section.

### BACKGROUND OF THE INVENTION

1. Field of the Invention

The present invention relates to a hand tool, and more particularly to a hand tool with an elbow structure.

2. Description of Related Art

A first conventional hand tool is shown in FIG. 6 comprising a handle (1′) and a rod (2′) extending from the handle (1′) along an axis of the handle (1′). A function head (3′) extends from the rod (2′) along an axis of the rod (2′). A driving unit (4′) perpendicularly extends form the function head (3′) for driving a fastener (not shown) such as a socket or a nut. A torque mechanism (not shown) is mounted in the rod (2′) and the handle (1′), and connected to the driving unit (4′) for providing a torque effect.

Nevertheless, if a fastener is positioned in a bottom of a sunken hole of a fastened object, a longitudinally length of the driving unit (4′) is not enough to drive the fastener in the sunken hole. Therefore, a lengthened driving unit is necessary to the first conventional hand tool for driving the fastener in the sunken hole.

With reference to FIG. 7, the second conventional hand tool comprises a handle (1″) having a rod (2″) extending therefrom along an axis of the handle (1″) and a driving unit (3″) extending from the rod (2″). The driving unit (3″) is L-shaped and includes a first part (31″) longitudinally connected to the rod (2″) and a second part (32″) perpendicularly extending from the first part (31″) for connecting to the fastener.

However, a distance between the handle (1″) of the second conventional hand tool and an upper surface of the fastened object is shortened when the second part (32″) of the driving unit (3″) is connected to the fastener in the sunken hole. A user's hand is easily collided with the upper surface of the fastened object when the user operates the second conventional hand tool.

The present invention has arisen to mitigate and/or obviate the disadvantages of the conventional hand tools.

### SUMMARY OF THE INVENTION

The main objective of the present invention is to provide a hand tool with an elbow structure, which has an elbow structure having a specific angle for preventing a handle form approaching to a datum of a fastened object.

To achieve the objective, the hand tool with an elbow structure in accordance with the present invention comprises a handle having a rod longitudinally extending therefrom along an axis of the handle and an elbow structure extending from the rod. The elbow structure has a first section longitudinally connected to the rod along an axis of the rod and a second section slantwise extending from the first section relative to the axis of the rod. The second section forms a first included angle with an axis of the first section and a range of the first included angle is located from 60° to 70°. A driving portion is disposed on a distal end of the second section to be adapted to drive a fastener along an axis of the second section. Whereby, the axis of the handle forms a second included angle with a datum of a fastened object, the first included angle is a complementary angle of the second included angle such that a range of the second included angle is located from 30° to 20° for prevent the handle from approaching to the datum of the fasten object when the driving portion is longitudinally connected to the fastener.

Further benefits and advantages of the present invention will become apparent after a careful reading of the detailed description with appropriate reference to the accompanying drawings.

### BRIEF DESCRIPTION OF THE DRAWINGS

FIG. 1 is a side plan view of a hand tool with an elbow structure in accordance with the present invention;

FIG. 2 is a perspective view of the hand tool with an elbow structure in accordance with the present invention;

FIG. 3 is an operational view of the hand tool in FIG. 2;

FIG. 4 is a side plan view of a second embodiment of the elbow structure of the hand tool in accordance with the present invention;

FIG. 5 is an operational view of the elbow structure in FIG. 4;

FIG. 6 is a perspective view of a first conventional hand tool in accordance with the prior art; and

FIG. 7 is a side plan view of a second conventional hand tool in accordance with the prior art.

### DETAILED DESCRIPTION OF THE INVENTION

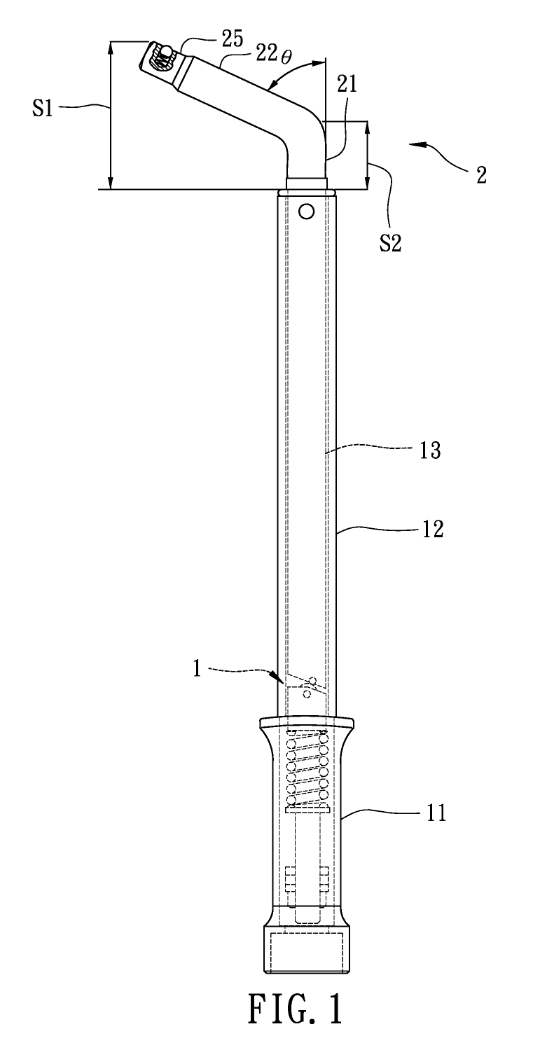

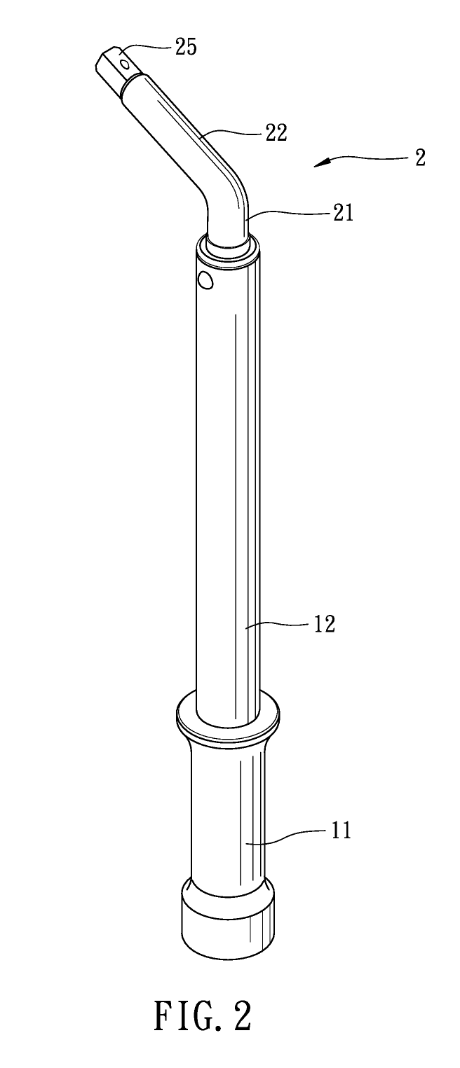

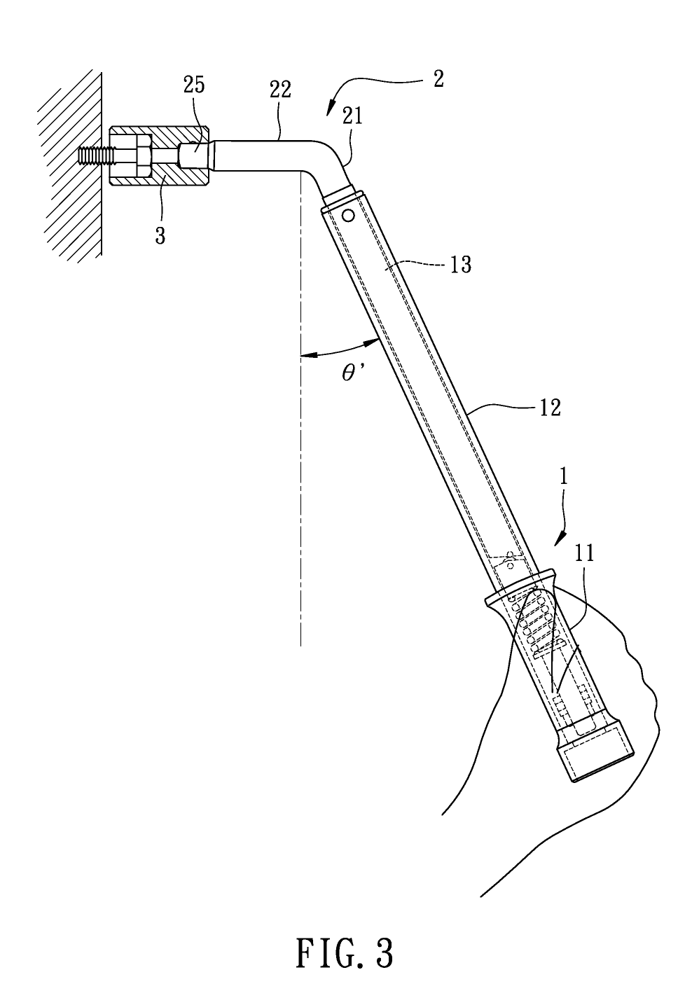

Referring to the drawings and initially to FIGS. 1-3, a hand tool with an elbow structure in accordance with the present invention comprises a handle (11) having a rod (12) extending therefrom along an axis of the handle (11) and an elbow structure (2) extending from the rod (12). The elbow structure (2) is adapted for driving a fastener (3).

The handle (11) and the rod (12) are hollow. A torque mechanism (1) is received in the handle (11) and the rod (12). The torque mechanism (1) has a spindle (13) extending through the rod (12) and longitudinally connected to the elbow structure (2) for measuring the torque from the elbow structure.

The elbow structure (2) has a first section (21) longitudinally connected to the spindle (13) along the axis of the rod (12), a second section (22) slantwise extending from the first section (21) relative to the axis of the rod (12), and a driving portion (25) formed on a distal end of the second section (22) along an axis of the second section (22). The driving portion (25) is adapted to drive the fastener (3). The second section (22) forms a first included angle (θ) with an axis of the first section (21) and a range of the first included angle (θ) is located from 60° to 70°. The axis of the handle (11) forms a second included angle (θ′) with a datum of a fastened object for preventing the handle (11) from approaching to the datum of the fasten object. The first included angle (θ) is a complementary angle of the second included angle (θ′) such that a range of the second included angle (θ′) is located from 30° to 20° when the driving portion (25) is longitudinally connected to the fastener (3). In that, if the fastened object has a sunken hole and the fastener (3) is positioned in a bottom of the sunken hole, a distance between a distal end of the handle (11) and the datum of the fastened object is provided to prevent the handle (11) from approaching to the datum of the fastened object.

The elbow structure has a right projection length (S1) relative to the axis of the rod (12) and the first section (21) of the elbow structure (21) has an extending length (S2), wherein a proportion of the projection length (S1) of the elbow structure (2) and the extending length (S2) of the first section (21) of the elbow structure (2) has a range located form 2:1 to 3:1. Therefore, the first included angle (θ) of the axis of the first section (21) and the second section (22) is fixed, and the proportion of the right projection length (S1) and the extending length (S2) is also fixed such that a proportion between the length of the second section (22) and the length of the first section (21) is calculated to have a range located from 2:1 to 7:1.

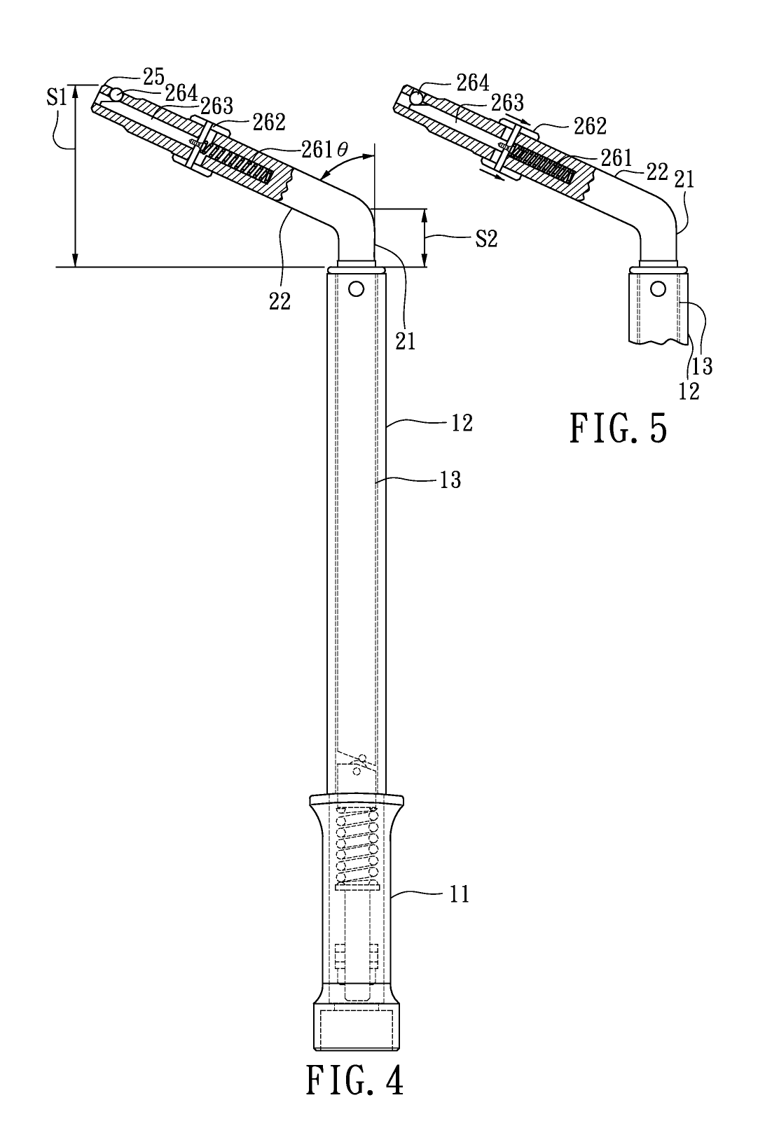

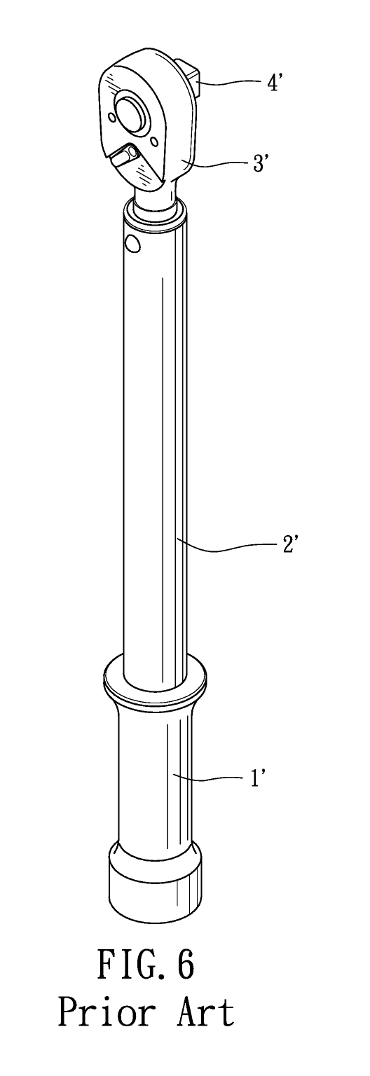

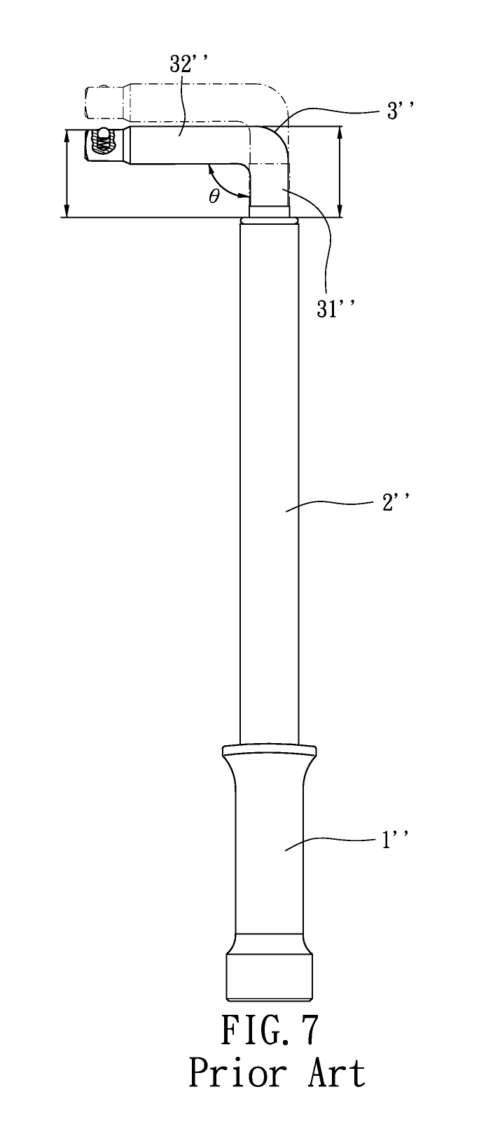

With reference to FIG. 4 and FIG. 5 that show a second embodiment of the elbow structure (2) of the present invention, the second section (22) and the driving portion (25) are hollow. An elastic member (261) is compressively received in the second section (22) and longitudinally connected to a movable member (262) for providing a restitution force to the movable member (262). In the preferred embodiment of the present invention, the elastic member (261) is a compressing spring. The movable member (262) is movably sleeved between the second section (22) and the driving portion (25). A shaft (263) is reciprocally movably received in the driving portion (25). The shaft (263) has a first end longitudinally fixed on the movable member (262) and a second end abutting against a metallic ball (264). The ball (264) is laterally and selectively received in the driving portion (25). The ball (264) is partially and laterally protruded out of the driving portion (25) when the shaft (263) and the movable member (262) are moved toward the ball (264) due to the restitution force of the elastic member (261) for locking the fastener. The ball (264) is fully received in the driving portion (25) when the shaft (263) and movable member (262) are moved toward the elastic member (261) for releasing the fastener.

Although the invention has been explained in relation to its preferred embodiment, it is to be understood that many other possible modifications and variations can be made without departing from the spirit and scope of the invention as hereinafter claimed.

What is claimed is:

1. A hand tool with an elbow structure comprising:
a handle having a rod longitudinally extending therefrom along an axis of the handle and an elbow structure extending from the rod, the elbow structure having a first section longitudinally connected to the rod along an axis of the rod and a second section slantwise extending from the first section relative to the axis of the rod, the second section forming a first included angle with an axis of the first section and a range of the first included angle being located from 60° to 70°, a driving portion disposed on a distal end of the second section to be adapted to drive a fastener along an axis of the second section, the axis of the handle forming a second included angle with a datum of a fastened object, the first included angle being a complementary angle of the second included angle such that a range of the second included angle is located from 30° to 20° for prevent the handle from approaching to the datum of the fasten object when the driving portion is longitudinally connected to the fastener.

2. The hand tool with an elbow structure as claimed in claim 1, wherein the elbow structure has a right projection length relative to the axis of the rod and the fist section of the elbow structure has an extending length, a proportion of the projection length of the elbow structure and the extending length of the first section of the elbow structure had a range located from 2:1 to 3:1.

3. The hand tool with an elbow structure as claimed in claim 1, wherein the handle and the rod are hollow, a spindle received in the rod and longitudinally connected to the first section of the elbow for measuring the torque from the elbow structure.

4. The hand tool with an elbow structure as claimed in claim 1, wherein the second section and the driving portion are hollow, an elastic member is compressively received in the second section and longitudinally connected to a movable member for providing a restitution force to the movable member, the movable member movably sleeved between the second section and the driving portion, a shaft reciprocally movably received in the driving portion, the shaft having a first end longitudinally fixed on the movable member and a second end abutting against a ball, the ball laterally and selectively received in the driving portion, and selectively and partially protruded out of the driving portion when the shaft and the movable member are moved due to the restitution force for locking the fastener.

5. The hand tool with an elbow structure as claimed in claim 2, wherein the handle and the rod are hollow, a spindle received in the rod and longitudinally connected to the first section of the elbow for measuring the torque from the elbow structure.

6. The hand tool with an elbow structure as claimed in claim 2, wherein the second section and the driving portion are hollow, an elastic member is compressively received in the second section and longitudinally connected to a movable member for providing a restitution force to the movable member, the movable member movably sleeved between the second section and the driving portion, a shaft reciprocally movably received in the driving portion, the shaft having a first end longitudinally fixed on the movable member and a second end abutting against a ball, the ball laterally and selectively received in the driving portion, and selectively and partially protruded out of the driving portion when the shaft and the movable member are moved due to the restitution force for locking the fastener.

7. The hand tool with an elbow structure as claimed in claim 3, wherein the second section and the driving portion are hollow, an elastic member is compressively received in the second section and longitudinally connected to a movable member for providing a restitution force to the movable member, the movable member movably sleeved between the second section and the driving portion, a shaft reciprocally movably received in the driving portion, the shaft having a first end longitudinally fixed on the movable member and a second end abutting against a ball, the ball laterally and selectively received in the driving portion, and selectively and partially protruded out of the driving portion when the shaft and the movable member are moved due to the restitution force for locking the fastener.
